(19) United States
(12) Patent Application Publication
(10) Pub. No.: US 2026/0122731 A1
(43) Pub. Date: Apr. 30, 2026

(54) Heating Pads, And Systems And Methods For Making And Using Same

(71) Applicant: University of Alaska Anchorage, Anchorage, AK (US)

(72) Inventors: Zhaohui Yang, Anchorage, AK (US); Timothy Allen, Anchorage, AK (US); Carl Swanson, Anchorage, AK (US)

(21) Appl. No.: 19/427,687

(22) Filed: Dec. 19, 2025

Related U.S. Application Data
(62) Division of application No. 18/008,888.
(60) Provisional application No. 63/037,940, filed on Jun. 11, 2020.

(51) Int. Cl. H05B 3/34

(52) U.S. Cl. CPC H05B 3/34

(57) ABSTRACT

A heating pad having at least one heating element positioned within an encapsulation layer. Each heating element has a carbon fiber tape layer and a conductive sheath surrounding the carbon fiber tape layer. Within each heating element, an insulation layer can be positioned between the carbon fiber tape layer and the conductive sheath. The carbon fiber tape layer of each heating element can have opposing ends to which electrodes can be secured. Systems and methods of using and making the heating pad are also disclosed.

### CROSS-REFERENCE TO RELATED APPLICATION

This application is a divisional application of U.S. patent application Ser. No. 18/008,888, filed, Dec. 7, 2002, which is a U.S. National Phase Application under 35 U.S.C. § 371 of International Application No. PCT/US2021/037027, filed on Jun. 11, 2021, which claims priority to and the benefit of the filing date of U.S. Provisional Ser. No. 63/037,940, filed Jun. 11, 2020. The content of these earlier filed applications is hereby incorporated herein by reference in its entirety.

### FIELD

This invention relates generally to heating pads that can be selectively applied to various surfaces for effective heating.

### BACKGROUND

Conventionally, permanent structures (such as concrete structures) can be provided with heating devices that are imbedded within the structures. Thus, after the structure is completed, it is not possible to access or reposition the heating devices. There is a need for improved systems and methods for selectively and externally heating various structures.

### SUMMARY

Disclosed herein is a heating pad having at least one heating element positioned within an encapsulation layer (optionally, a waterproof encapsulation layer) that defines an outer surface of the heating pad. Each heating element can have a carbon fiber tape layer and a conductive sheath surrounding the carbon fiber tape layer. Optionally, the heating element can have an electrically insulating material positioned between the carbon fiber tape layer and the conductive sheath. Optionally, the at least one heating element can have a plurality of heating sections. Optionally, the plurality of heating sections can form a continuous structure within the heating pad. Optionally, the heating pad comprises a thermally conductive material positioned between the plurality of heating sections, with the at least one heating element and the thermally conductive material defining a heating layer. The outer surface of the heating pad can comprise a contact portion and an opposing base portion, and the contact portion can be adjacent to the heating layer and configured to permit transfer of heat from the plurality of heating sections to the contact portion. Optionally, the heating pad can further comprise an insulation layer positioned between the base portion and the heating layer.

Also disclosed are methods for securing an electrode to a carbon fiber tape layer. Such methods can include: bending a first end portion of a first conductive plate toward a base portion of the first conductive plate such that the end portion and the base portion of the first conductive plate define a receiving space; inserting a first end portion of a carbon fiber tape layer within the receiving space of the first conductive plate; further bending the first end portion of the first conductive plate to compress the end portion of the carbon fiber tape layer within the receiving space of the first conductive plate; and bending a second, opposed end portion of the first conductive plate over the first end portion of the first conductive plate to form a first electrode. The disclosed method can be repeated on the opposing side of the carbon fiber tape layer to form a second electrode.

After the electrodes are formed using the carbon fiber tape layer, additional steps as further disclosed herein can be followed to produce a heating pad.

### BRIEF DESCRIPTION OF THE DRAWINGS

The accompanying drawings, which are incorporated in and constitute a part of this specification, illustrate several embodiments of the disclosed apparatus, system, and method and together with the description, serve to explain the principles of the disclosed apparatus, system, and method.

FIG. 1 is a cross-sectional view of an exemplary heating pad as disclosed herein.

FIG. 2A is a cross-sectional view of a conductive plate during bending of a first end portion of the plate as disclosed herein.

FIG. 2B is a cross-sectional view schematically depicting the insertion of an end portion of a carbon fiber tape layer within a receiving space of a conductive plate as disclosed herein.

FIG. 2C is a cross-sectional view schematically depicting the bending of a second end portion of the plate as disclosed herein.

FIG. 3 is a top view depicting the formation of a hole within an electrode as disclosed herein.

FIG. 4A depicts an outer surface of a conductive sheath in a desired layout as disclosed herein. As shown, an electrically insulating material is positioned underneath the conductive sheath layer, with edges of the electrically insulating material extending outwardly from the edges of the conductive sheath layer.

FIG. 4B depicts an inner surface of the conductive sheath and electrically insulating material of FIG. 4A (after being flipped over), with only the electrically insulating material being visible.

FIG. 4C depicts the positioning of a carbon fiber tape layer in a desired layout that is configured to overlie the layout of the conductive sheath of FIG. 4B.

FIG. 4D depicts the connection of hot and neutral wires to ring connectors that are secured to one of the two electrodes of the carbon fiber tape layer as disclosed herein. As shown, the electrodes can be fastened to an electrically insulating termination block.

FIG. 4E depicts the positioning of a second conductive sheath over a heating element as disclosed herein. As shown, a grounding wire can be connected to the conductive sheath via an electrode as disclosed herein.

FIG. 5A schematically depicts a system comprising a heating pad that is in contact with a vertically oriented substrate. FIG. 5B schematically depicts a system comprising a heating pad that is in contact with a horizontally oriented substrate.

### DETAILED DESCRIPTION

The present invention can be understood more readily by reference to the following detailed description, which include examples, drawings, and claims. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an,” and “the” include plural referents unless the context clearly dictates otherwise. Thus, for example, reference to “an electrode”can include two or more such electrodes unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Optionally, in some aspects, when values or characteristics are approximated by use of the antecedents “about,” “substantially,” or “generally,” it is contemplated that values within up to 15%, up to 10%, up to 5%, or up to 1% (above or below) of the particularly stated value or characteristic can be included within the scope of those aspects.

Unless defined otherwise, all technical and scientific terms used herein have the same meanings as commonly understood by one of skill in the art to which the disclosed apparatus, system, and method belong. Although any apparatus, systems, and methods and materials similar or equivalent to those described herein can be used in the practice or testing of the present apparatus, system, and method, the particularly useful methods, devices, systems, and materials are as described.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

As used herein, the terms “optional” or “optionally” mean that the subsequently described event or circumstance may or may not occur, and that the description includes instances where said event or circumstance occurs and instances where it does not.

Disclosed herein, in exemplary aspects, are heating pads and methods of making such heating pads. As further described below, the disclosed heating pads can be placed directly underneath a concrete structure, or applied to any vertical or horizontal surface or structure for effective heating. The disclosed heating pads can promote and provide uniform heat transfer in a desired direction. During formation of the heating pads, electrodes can be formed on end portions of a carbon fiber tape layer that serves as the heating element within the heating pad. Wire connections can apply current to the carbon fiber tape layer through the electrodes, and the carbon fiber tape layer can generate heat that is transferred through the heating pad to a desired structure or surface. Various layouts of the carbon fiber tape layer and insulating materials can be employed within the heating pads.

### The Heating Pads

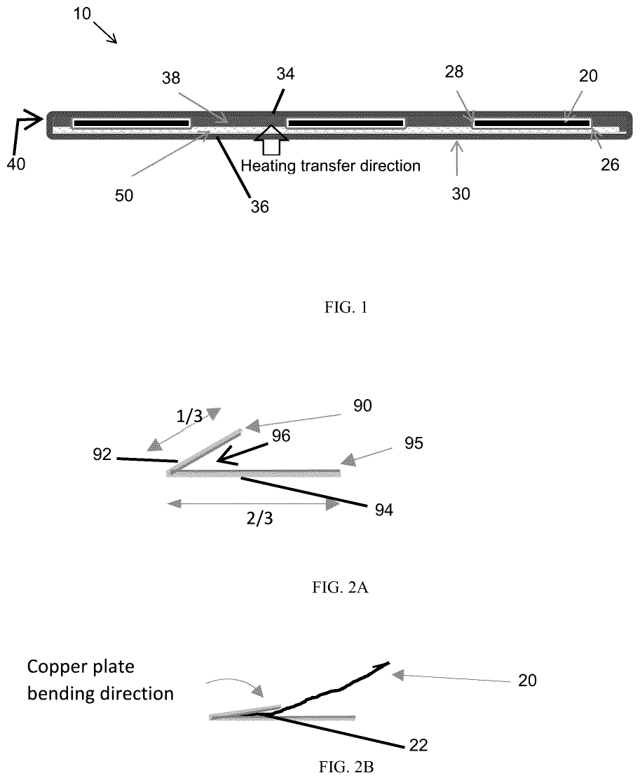

With reference to FIG. 1, a heating pad 10 can comprise at least one heating element 12. Each heating element 12 can have a carbon fiber tape layer 20 and a conductive sheath 26 surrounding the carbon fiber tape layer. As used herein, the term “carbon fiber tape” refers to conventional carbon fiber heater tape or carbon fiber rope as is known in the art. As is well-known in the art, upon application of current to such carbon fiber tape, the carbon fiber tape can generate heat. In exemplary aspects, the conductive sheath 26 can comprise copper (optionally, copper tape or copper foil). Optionally, as further disclosed herein, the conductive sheath 26 can comprise multiple (e.g., upper and lower) layers of conductive material that cooperate to enclose or surround the carbon fiber tape layer. Alternatively, it is contemplated that the conductive sheath 26 can be a contiguous sheet of material that extends circumferentially around the carbon fiber tape layer. In additional aspects, the heating pad 10 can comprise an encapsulation layer 30 (optionally, a waterproof encapsulation layer) that defines an outer surface 32 of the heating pad. As shown in FIG. 1, the at least one heating element 12 can be positioned within the encapsulation layer 30. It is contemplated that a waterproof encapsulation layer can permit usage of the disclosed heating pad in a variety of environments that may be exposed to moisture or other conditions that would typically be harmful to electrical components. In exemplary aspects, the encapsulation layer can comprise silicone, epoxy, polyurethane, or other rubber or polymeric material. Optionally, the encapsulation layer can comprise a silicone elastomer, such as for example, ARLON silicone (Rogers Corporation). However, it is contemplated that other sealant, coating, and/or insulating materials as are known in the art can be used to form an encapsulation layer as disclosed herein.

In further aspects, the encapsulation layer can comprise an electrically insulating material as is known in the art. Optionally, in these aspects, the encapsulation layer can comprise self-fusing tape, such as ARLON silicon self-fusing tape (Rogers Corporation).

In exemplary aspects, at least one heating element 12 (optionally, each heating element) can have an insulation layer (electrically insulating material 28) positioned between the carbon fiber tape layer 20 and the conductive sheath 26. In use, the electrically insulating material 28 can isolate the at least one heating element from the conductive, grounding sheath 26 as disclosed herein. In exemplary aspects, the electrically insulating material 28 can comprise electrical insulation paper (e.g., “fish paper”) or electrical insulation film as is known in the art. For example, the insulation layer 50 can comprise vulcanized cellulose fiber.

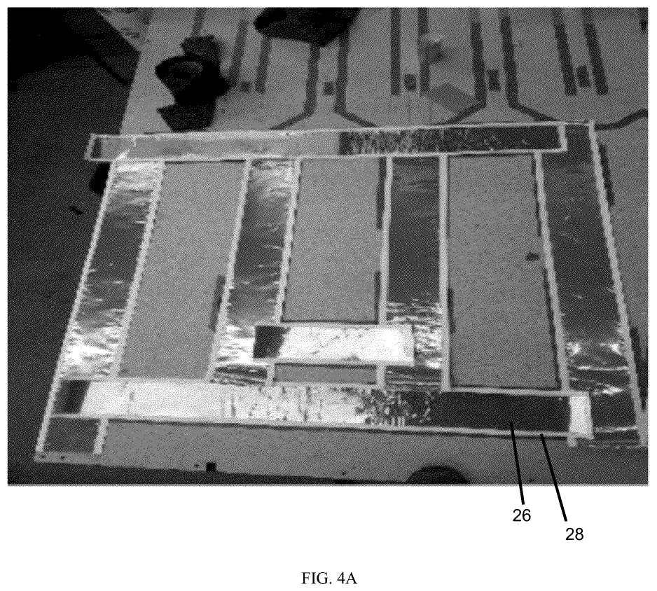

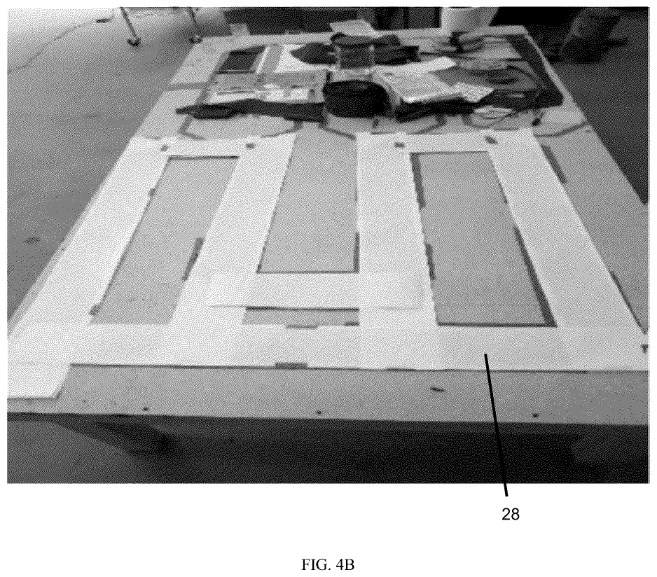

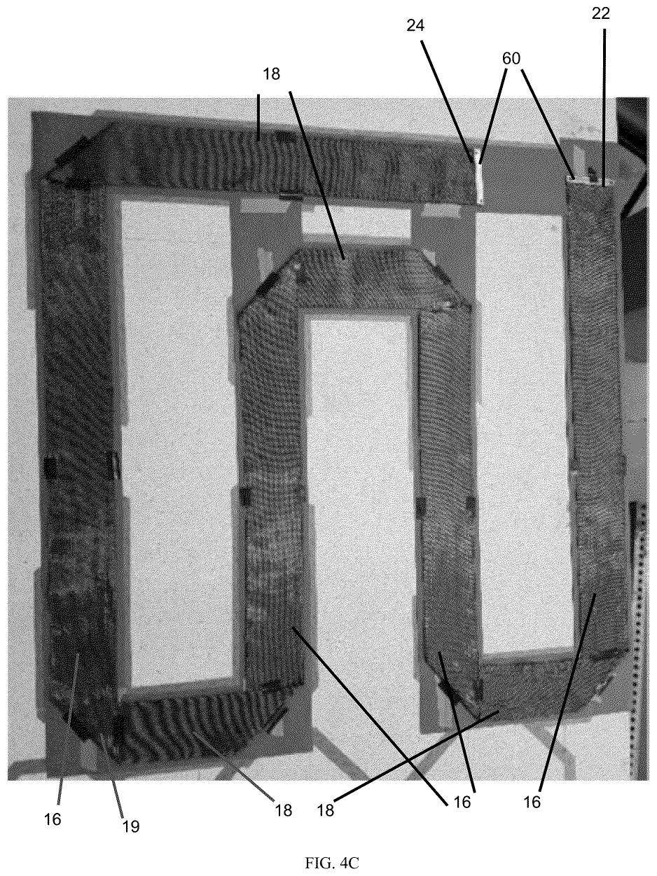

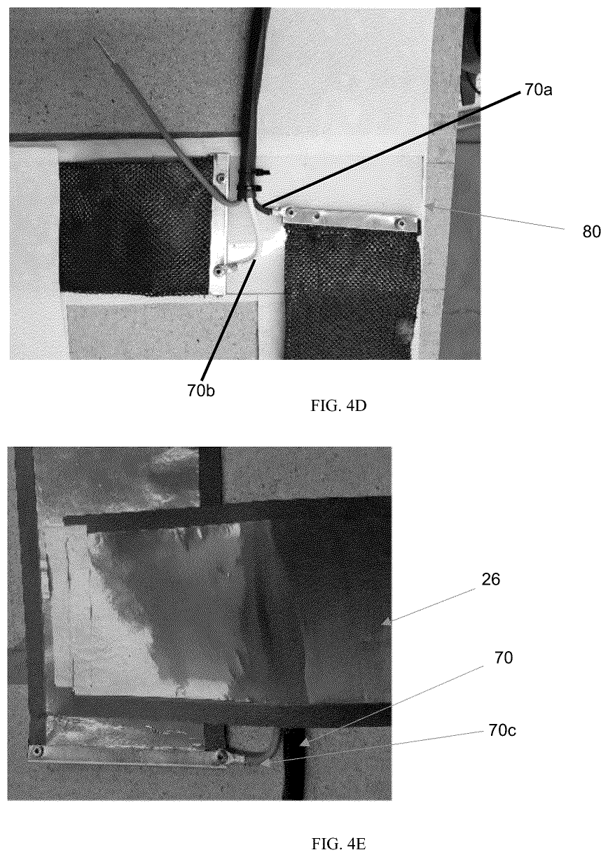

As shown in FIG. 4C, it is contemplated that the at least one heating element 12 can comprise a plurality of heating sections 14. In the specific example depicted in FIG. 4C, a single carbon fiber tape structure includes the plurality of heating sections 14. In some exemplary aspects, it is contemplated that the plurality of heating element sections 14 can form a continuous structure within the heating pad 10 (as part of a single heating element 12). In other aspects, it is contemplated that the plurality of heating sections 14 can be distributed among a plurality of heating elements 12 that are spaced apart within a single heating pad.

In exemplary aspects, and as shown in FIG. 1, a thermally conductive material 38 can be positioned between the plurality of heating sections 14. In these aspects, the at least one heating element 12 and the thermally conductive material 38 can define a heating layer 40. Exemplary thermally conductive materials include electrically insulating, thermally conductive materials as are known in the art, such as silicone rubbers or epoxies filled with boron nitride or aluminum nitride.

In further exemplary aspects, the outer surface 32 of the heating pad 10 can comprise a contact portion 34 and an opposing base portion 36. In these aspects, the contact portion 34 can be adjacent the heating layer 40 and configured to permit transfer of heat from the plurality of heating sections 14 to the contact portion, which can be placed in direct contact with a selected structure or surface (a substrate as further described herein).

Optionally, as depicted in FIG. 1, the heating pad 10 can further comprise an insulation layer 50 positioned between the base portion 36 and the heating layer 40. In one example, the insulation layer 50 can comprise a reflective insulation material as is known in the art, such as those manufactured by AEROLAM. In exemplary aspects, the insulation layer 50 can comprise aluminum foil.

Optionally, as shown in FIG. 4C, it is contemplated that the plurality of heating sections 14 can comprise a plurality of parallel heating sections 16 that are oriented parallel or substantially parallel to one another. In additional optional aspects, the plurality of heating 14 sections can further comprise at least one transverse heating section 18 that is oriented perpendicular or substantially perpendicular to the plurality of parallel heating sections 16. In still further aspects, at least two of the parallel heating sections 16 can be connected together via a transverse heating section 18. In these aspects, it is contemplated that a parallel heating section 16 can be joined to a transverse heating section 18 by a transition region 19 that is angled relative to the parallel and transverse heating sections as shown in FIG. 4C. Optionally, it is contemplated that the transition regions 19 can correspond to portions of a contiguous carbon fiber tape that are folded to change the orientation of the carbon fiber tape moving along the length of the carbon fiber tape, thereby defining respective parallel and transverse heating sections. Optionally, it is contemplated that the change in orientation from a parallel heating section 16 to a transverse heating section 18 can be about 90 degrees.

As shown in FIGS. 4C-4D, it is contemplated that the carbon fiber tape layer 20 can have opposing end portions 22, 24 that are proximate each other. For example, it is contemplated that the end portions 22, 24 of the carbon fiber tape layer 20 can be secured to a single termination block 80. As another example, it is contemplated that electrical wiring extending from a common bundle of wires can easily reach both end portions 22, 24 of the carbon fiber tape layer 20 as further described herein, thereby allowing for formation of a single port in the encapsulation layer of the heating pad. In one example, the end portions 22, 24 of the carbon fiber tape layer 20 can be spaced apart by 1 cm up to about 25 cm.

As shown in FIGS. 3 and 4C-4E, the heating pad 10 can further comprise an electrode 60 secured to an end portion 22, 24 of the carbon fiber tape layer 20. In additional aspects, the heating pad can further comprise at least one wire 70 that is electrically connected to the electrode 60.

In exemplary aspects, the heating pad can comprise a plurality of electrodes 60. In these aspects, it is contemplated that a respective electrode of the plurality of electrodes can be secured to the end portion of each of said end portions 22, 24 of the carbon fiber tape layer 20. Exemplary methods for securing electrodes 60 to the end portion of the carbon fiber tape layer 20 are described further herein. In additional aspects, the heating pad 10 can further comprise a plurality of wires 70. In these aspects, at least one wire of the plurality of wires 70 can be electrically connected to each respective electrode of the plurality of electrodes 60. In further aspects, it is contemplated that the end portions 22, 24 of the carbon fiber tape layer 20 can be defined, respectively, by a first heating section of the plurality of parallel heating sections 16 and a second heating section of the at least one transverse heating section 18.

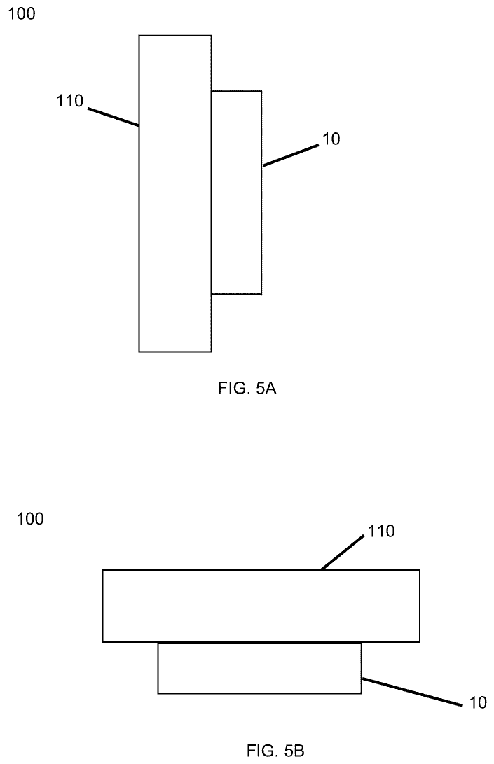

In use, it is contemplated that the heating pad 10 can provide heat to one or more structures within a system 100. In exemplary aspects, and with reference to FIGS. 5A-5B, the system 100 can comprise a substrate 110 and the heating pad 10, with the heating pad being secured in contact with the substrate. More particularly, it is contemplated that the contact portion of the heating pad can be secured in contact with a selected portion of the substrate 110. Optionally, the substrate 110 can be a concrete structure. Optionally, the substrate 110 can comprise concrete, sand, filler, insulation board, or combinations thereof, and the heating pad can be in contact with any of these materials. Optionally, as shown in FIG. 5A, the substrate 110 can be a vertical or substantially vertically oriented structure. Optionally, as shown in FIG. 5B, the substrate 110 can be a horizontal or substantially horizontally oriented structure.

Methods of using the disclosed heating pad can comprise securing the heating pad in contact with a substrate and delivering current to the carbon fiber tape layer of the heating pad to transfer heat to the substrate. In some exemplary aspects, it is contemplated that the heating pad can be used in deicing applications. More particularly, in these aspects, the heating pad can be positioned under or within structures having an outer surface where ice or snow accumulates, and the heating pad can be used to melt the ice or snow. In further aspects, it is contemplated that the heating pad can be electrically and communicatively connected to an electrical controller/generator as is known in the art.

### Methods of Making the Heating Pads

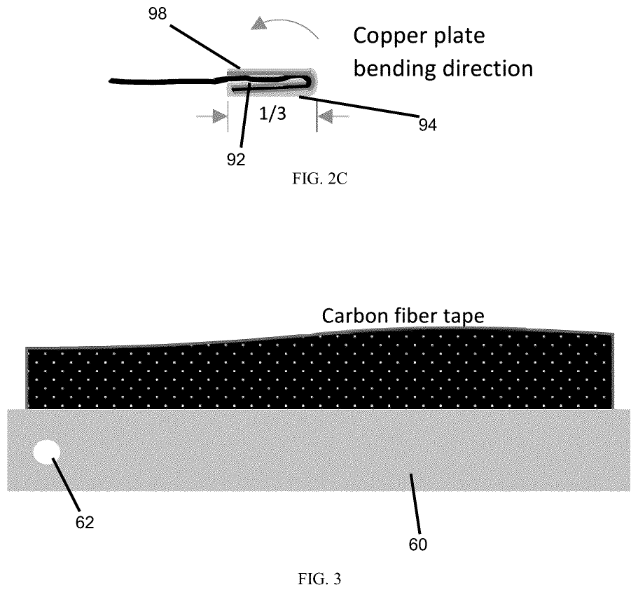

In exemplary aspects, and with reference to FIGS. 2A-3, a method for forming an electrode on a carbon fiber tape layer is disclosed. In one aspect, as shown in FIG. 2A, the method can comprise bending a first end portion 92 of a first conductive plate 90 toward a base portion 94 of the first conductive plate such that the end portion 92 and the base portion 94 of the first conductive plate 90 define a receiving space 96. In another aspect, as shown in FIG. 2B, the method can comprise inserting a first end portion 22 of a carbon fiber tape layer within the receiving space 96 of the first conductive plate 90. In another aspect, the method can comprise further bending the first end portion 92 of the first conductive plate 90 to compress the first end portion 22 of the carbon fiber tape layer 20 within the receiving space 96 of the first conductive plate 90. In a further aspect, as shown in FIG. 2C, the method can comprise bending a second, opposed end portion 98 of the first conductive plate 90 over the first end portion 92 of the first conductive plate to form a first electrode 60.

Optionally, it is contemplated that the conductive plate can comprise copper.

Optionally, with reference to FIGS. 2A-2C, the first end portion, the second end portion, and the base portion of the first conductive plate can have substantially equal lengths. That is, the first end portion, the second end portion, and the base portion can each have a length that is equal or substantially equal to one-third of a total length of the conductive plate. For example, in exemplary aspects, a 4-inch by 1.5-inch copper plate can be bent to produce a folded structure having a length of 4 inches, a width of 0.5 inches, and a thickness of less than 0.5 inches (optionally, less than 0.25 inches). As shown in FIG. 2A, the initial bend of the first end portion 92 can be made at a location where the width of the first end portion is equal to about one-third of the total width of the conductive plate (prior to folding).

In order to form a second electrode, the method can be repeated on the opposing side of the carbon fiber tape layer. More particularly, the method can further comprise bending a first end portion of a second conductive plate toward a base portion of the second conductive plate such that the end portion and the base portion of the second conductive plate define a receiving space. The method can further comprise inserting a first end portion of a carbon fiber tape layer within the receiving space of the second conductive plate. The method can still further comprise further bending the first end portion of the second conductive plate to compress the end portion of the carbon fiber tape layer within the receiving space of the second conductive plate. The method can still further comprise bending a second, opposed end portion of the second conductive plate over the first end portion of the first conductive plate to form a second electrode.

Optionally, prior to bending of the end portions of the conductive plate, it is contemplated that an inner surface of the conductive plate can be coated with an electrically conductive gel 95 as is known in the art (optionally, an electrode gel), which can comprise electrically conductive polymers.

In exemplary aspects, and with reference to FIG. 3, the method can further comprise forming at least one hole 62 through a portion of a thickness of at least one of (optionally, each of) the first and second electrodes 60. In these aspects, it is contemplated that the hole can be configured to receive electrical wiring 70 that can be electrically connected to the electrode and the carbon fiber tape layer (and provide current from a power supply to the carbon fiber tape layer). It is contemplated that the power supply can be configured to supply either DC or AC current. In the case of AC current, it is contemplated that the hole through a first electrode can receive a hot wire 70a, while the second electrode, which can optionally include a second hole that receives a second wire 70b, can complete the circuit. In the case of DC current, it is contemplated that the hole through a first electrode can receive a positive terminal/pole (e.g., a first wire), while the hole of the second electrode can receive a negative terminal/pole (e.g., a second wire).

In additional aspects, and with reference to FIGS. 4A-4B, the method can further comprise positioning a first conductive sheath layer (e.g., copper tape) in a desired layout. In these aspects, and with reference to FIG. 4C, the method can further comprise positioning the carbon fiber tape layer over the first conductive sheath layer such that the carbon fiber tape layer is supported in a desired pattern.

In further aspects, the method can comprise connecting electrical wiring configured to supply power to at least one of the first and second electrodes. Optionally, as shown in FIG. 4D, the method can further comprise securing the first and second electrodes to a termination block.

In still further aspects, and with reference to FIG. 4E, the method can comprise positioning a second conductive sheath layer (e.g., copper tape) over the carbon fiber tape layer to form a heating element. In these aspects, it is contemplated that the first and second conductive sheath layers can cooperate to form a single conductive sheath that surrounds the carbon fiber tape layer.

Optionally, prior to positioning the carbon fiber tape layer over the first conductive sheath layer, the method can comprise positioning electrically insulating material on the first conductive sheath layer. In these aspects, positioning the carbon fiber tape layer over the first conductive sheath layer can comprise positioning the carbon fiber tape layer on the electrically insulating material positioned on the first conductive sheath layer. Optionally, prior to positioning the second conductive sheath layer over the carbon fiber tape layer, the method can further comprise positioning electrically insulating material on the carbon fiber tape layer. In these aspects, positioning the second conductive sheath layer over the carbon fiber tape layer can comprise positioning the second conductive sheath layer on the electrically insulating material positioned on the carbon fiber tape layer. Thus, it is contemplated that the two layers of electrically insulating material can cooperate to define a single layer of electrically insulating material that circumferentially surrounds the carbon fiber tape layer and is circumferentially surrounded by the conductive sheath. In further aspects, and as shown in FIG. 4A, it is contemplated that the electrically insulating material can have a width that is greater than a width of the conductive sheath layers, such that the insulating material extends outwardly from side edges of the conductive sheath layers and ensures that the insulating material is positioned between the conductive sheath layers and the carbon fiber tape layer.

In additional aspects, the method can further comprise connecting a grounding wire 70c to one or more of the first and second conductive sheath layers through the first electrode.

In additional aspects, the method can comprise applying an encapsulation layer over the heating element to define an outer surface of a heating pad. In these aspects, it is contemplated that the heating element can be positioned within the encapsulation layer. It is further contemplated that the encapsulation layer can comprise an electrically insulating material. In further aspects, it is contemplated that the heating element can comprise a plurality of heating sections. Optionally, in these aspects, the plurality of heating sections can form a continuous structure within the heating pad.

In still further aspects, the method can comprise positioning a thermally conductive material between the plurality of heating sections. In these aspects, as further disclosed herein, the thermally conductive material and the heating element can cooperate to define a heating layer.

In exemplary aspects, the outer surface of the heating pad can comprise a contact portion and an opposing base portion. In these aspects, the contact portion can be adjacent the heating layer and configured to permit transfer of heat from the plurality of heating sections to the contact portion. Optionally, prior to applying the encapsulation layer, the method can further comprise positioning an insulation layer between the base portion of the outer surface of the heating pad and the heating layer. In these aspects, it is contemplated that the insulation layer between the base portion of the outer surface of the heating pad and the heating layer comprises a thermally reflective material.

Optionally, in further exemplary aspects, the plurality of heating sections can comprise a plurality of parallel heating sections that are oriented substantially parallel to one another. Optionally, in these aspects, the plurality of heating sections further can comprise at least one transverse heating section oriented substantially perpendicular to the plurality of parallel heating sections. In these aspects, it is contemplated that at least two of the parallel heating sections are connected together via a transverse heating section. In still further aspects, the first and second electrodes can be secured, respectively, to a first heating section of the plurality of parallel heating sections and a second heating section of the at least one transverse heating section.

### An Example Method for Forming a Heating Pad

### Forming Electrodes

Forming reliable electrodes at the ends of a carbon fiber tape is a challenging task. Described below with reference to FIGS. 2A-2C is an exemplary 3-step method for making electrodes by copper plates or similar conductive material. Optionally, the surface of the copper plate can be coated with a layer of conductive gel.
(a) As shown in FIG. 2A, a third of the copper plate of certain thickness and length is bent to a certain angle from perpendicular along the longitudinal axis.
(b) As shown in FIG. 2B, one end of the raw carbon fiber tape is inserted into the bend and the top third is pressed flat. Care shall be taken so that the carbon fiber tape is centered along the longitudinal dimension to ensure no tape extends beyond the ends of the copper plate
(c) As shown in FIG. 2C, the ⅓ copper plate to the right is folded over again and pressed flat to ensure a tight clamp fit. Note that no tape is to extend beyond the ends of the copper plate. A final electrode with the same length and ⅓ of the copper plate width is formed.

Steps a) through c) are performed on the other end of the carbon fiber tape to form the other electrode. As shown in FIG. 3, one hole of certain diameter for power supply wiring is made centered on the copper electrode at one end and should not be placed too close from the end of the electrode. In exemplary aspects, the hole for the power supply wiring can be spaced from the end of the electrode by at least 0.5 inches.

### Insulation, Layout, and Wire Connections

The following steps a) through e) illustrate how a heating pad having a single carbon fiber heating element can be fabricated. This method can be adapted for a heating element with multiple heating elements connected by a parallel circuit.
(a) As shown in FIG. 4A, a conductive sheath with the same configuration as the heating element layout is prepared first. The photograph exemplifies a conductive sheath secured atop of an electrically insulating layer for a heating pad with one heating element.
(b) As shown in FIG. 4B, the conductive sheath (with heating pad) is next turned over.
(c) As shown in FIG. 4C, the carbon fiber tape of certain length is then laid atop the conductive sheath along its center line as shown and is held in place prior to encapsulation.
(d) As shown in FIG. 4D, the hot wire 70a and neutral wire 70b are next connected to ring connectors which are secured to one of the two electrodes as shown below. An electrically insulating termination block 80 can be used to fasten the electrodes.
(e) As shown in FIG. 4E, steps a) and b) can be repeated to construct a second conductive sheath, which can be optionally placed on top of the assembly to provide a second grounding plate on the other side of the heating element. Next, the grounding wire 70c is attached to the conductive sheath(s) using a crimped copper electrode, rivets, and crimp connector similar to the power connections, as shown.

### Promotion of Uniform Heat Transfer in a Desired Direction

As shown in FIG. 1, to direct the heat uniformly to a desired surface, a thermal reflective insulation layer of certain thickness can be placed on one side of the finished configuration, and the gaps between the heating elements can be filled with thermally conductive material before encapsulation with electrically insulating material. This design can help promote more uniform heat transfer to a surface on the opposite side to the thermal reflective insulation.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A heating pad comprising: at least one heating element, each heating element having: a carbon fiber tape layer; and a conductive sheath surrounding the carbon fiber tape layer; and an encapsulation layer defining an outer surface of the heating pad, wherein the at least one heating element is positioned within the encapsulation layer.

Aspect 2: The heating pad of aspect 1, wherein each heating element has an electrically insulating material positioned between the carbon fiber tape layer and the conductive sheath.

Aspect 3: The heating pad of aspect 1 or aspect 2, wherein the encapsulation layer comprises an electrically insulating material.

Aspect 4: The heating pad of any one of aspects 1-3, wherein the at least one heating element comprises a plurality of heating sections.

Aspect 5: The heating pad of aspect 4, wherein the plurality of heating element sections form a continuous structure within the heating pad.

Aspect 6: The heating pad of aspect 5, further comprising a thermally conductive material positioned between the plurality of heating sections, wherein the at least one heating element and the thermally conductive material define a heating layer.

Aspect 7: The heating pad of aspect 6, wherein the outer surface of the heating pad comprises a contact portion and an opposing base portion, and wherein the contact portion is adjacent the heating layer and configured to permit transfer of heat from the plurality of heating sections to the contact portion.

Aspect 8: The heating pad of aspect 7, wherein the heating pad further comprises an insulation layer positioned between the base portion and the heating layer.

Aspect 9: The heating pad of aspect 8, wherein the insulation layer comprises a thermally reflective material.

Aspect 10: The heating pad of any one of aspects 7-9, wherein the plurality of heating sections comprises a plurality of parallel heating sections that are oriented substantially parallel to one another.

Aspect 11: The heating pad of aspect 10, wherein the plurality of heating sections further comprises at least one transverse heating section oriented substantially perpendicular to the plurality of parallel heating sections, wherein at least two of the parallel heating sections are connected together via a transverse heating section.

Aspect 12: The heating pad of any one of aspects 5-11, wherein the carbon fiber tape layer has opposing end portions that are proximate each other.

Aspect 13: The heating pad of aspect 12, further comprising an electrode secured to an end portion of the carbon fiber tape layer.

Aspect 14: The heating pad of aspect 13, further comprising at least one wire that is electrically connected to the electrode.

Aspect 15: The heating pad of aspect 12, further comprising a plurality of electrodes, wherein a respective electrode of the plurality of electrodes is secured to the end portion of each of said end portions of the carbon fiber tape layer.

Aspect 16: The heating pad of aspect 15, further comprising a plurality of wires, wherein at least one wire of the plurality of wires is electrically connected to each respective electrode of the plurality of electrodes.

Aspect 17: The heating pad of aspect 15 or aspect 16, wherein the end portions of the carbon fiber tape layer are defined, respectively, by a first heating section of the plurality of parallel heating sections and a second heating section of the at least one transverse heating section.

Aspect 18: The heating pad of aspect 17, further comprising a termination block, wherein the end portions of the carbon fiber tape layer are secured to the termination block.

Aspect 19: A system comprising: a substrate; and the heating pad of any one of aspects 1-18, wherein the heating pad is secured in contact with the substrate.

Aspect 20: The system of aspect 19, wherein the substrate is a concrete structure.

Aspect 21: The system of aspect 19 or aspect 20, wherein the substrate is a vertical structure.

Aspect 22: The system of aspect 19 or aspect 21, wherein the substrate is a horizontal structure.

Aspect 23: A method of using the heating pad of any one of aspects 1-18, comprising: securing the heating pad in contact with a substrate; and delivering current to the carbon fiber tape layer of the heating pad to transfer heat to the substrate.

Aspect 24: A method comprising: bending a first end portion of a first conductive plate toward a base portion of the first conductive plate such that the end portion and the base portion of the first conductive plate define a receiving space; inserting a first end portion of a carbon fiber tape layer within the receiving space of the first conductive plate; further bending the first end portion of the first conductive plate to compress the end portion of the carbon fiber tape layer within the receiving space of the first conductive plate; bending a second, opposed end portion of the first conductive plate over the first end portion of the first conductive plate to form a first electrode.

Aspect 25: The method of aspect 24, wherein the conductive plate comprises copper.

Aspect 26: The method of aspect 24 or aspect 25, wherein the first end portion, the second end portion, and the base portion of the first conductive plate have substantially equal lengths.

Aspect 27: The method of any one of aspects 24-26, further comprising: bending a first end portion of a second conductive plate toward a base portion of the second conductive plate such that the end portion and the base portion of the second conductive plate define a receiving space; inserting a first end portion of a carbon fiber tape layer within the receiving space of the second conductive plate; further bending the first end portion of the second conductive plate to compress the end portion of the carbon fiber tape layer within the receiving space of the second conductive plate; and bending a second, opposed end portion of the second conductive plate over the first end portion of the first conductive plate to form a second electrode.

Aspect 28: The method of aspect 27, further comprising: forming at least one hole through a portion of a thickness of each of the first and second electrodes, wherein the hole is configured to receive electrical wiring.

Aspect 29: The method of aspect 27 or aspect 28, further comprising: positioning a first conductive sheath layer in a desired layout; and positioning the carbon fiber tape layer over the first conductive sheath layer such that the carbon fiber tape layer is supported in a desired pattern.

Aspect 30: The method of aspect 29, further comprising: connecting electrical wiring configured to supply power to at least one of the first and second electrodes.

Aspect 31: The method of aspect 29 or aspect 30, further comprising: securing the first and second electrodes to a termination block.

Aspect 32: The method of aspect 30 or aspect 31, further comprising: positioning a second conductive sheath layer over the carbon fiber tape layer to form a heating element.

Aspect 33: The method of aspect 32, further comprising: prior to positioning the carbon fiber tape layer over the first conductive sheath layer, positioning electrically insulating material on the first conductive sheath layer, wherein positioning the carbon fiber tape layer over the first conductive sheath layer comprises positioning the carbon fiber tape layer on the electrically insulating material positioned on the first conductive sheath layer.

Aspect 34: The method of aspect 33, further comprising: prior to positioning the second conductive sheath layer over the carbon fiber tape layer, positioning electrically insulating material on the carbon fiber tape layer, wherein positioning the second conductive sheath layer over the carbon fiber tape layer comprises positioning the second conductive sheath layer on the electrically insulating material positioned on the carbon fiber tape layer.

Aspect 35: The method of any one of aspects 32-34, further comprising: connecting a grounding wire to one or more of the first and second conductive sheath layers through the first electrode.

Aspect 36: The method of any one of aspects 32-35, further comprising: applying an encapsulation layer over the heating element to define an outer surface of a heating pad, wherein the heating element is positioned within the encapsulation layer.

Aspect 37: The method of aspect 36, wherein the encapsulation layer comprises an electrically insulating material.

Aspect 38: The method of aspect 36 or aspect 37, wherein the heating element comprises a plurality of heating sections.

Aspect 39: The method of aspect 38, wherein the plurality of heating sections form a continuous structure within the heating pad.

Aspect 40: The method of aspect 39, further comprising: positioning a thermally conductive material between the plurality of heating sections, wherein the thermally conductive material and the heating element cooperate to define a heating layer.

Aspect 41: The method of aspect 40, wherein the outer surface of the heating pad comprises a contact portion and an opposing base portion, and wherein the contact portion is adjacent the heating layer and configured to permit transfer of heat from the plurality of heating sections to the contact portion.

Aspect 42: The method of any one of aspects 36-41, further comprising: prior to applying the encapsulation layer, positioning an insulation layer between the base portion of the outer surface of the heating pad and the heating layer.

Aspect 43: The method of aspect 42, wherein the insulation layer between the base portion of the outer surface of the heating pad and the heating layer comprises a thermally reflective material.

Aspect 44: The method of any one of aspects 39-43, wherein the plurality of heating sections comprises a plurality of parallel heating sections that are oriented substantially parallel to one another.

Aspect 45: The method of aspect 44, wherein the plurality of heating sections further comprise at least one transverse heating section oriented substantially perpendicular to the plurality of parallel heating sections, wherein at least two of the parallel heating sections are connected together via a transverse heating section.

Aspect 46: The method of aspect 45, wherein the first and second electrodes are secured, respectively, to a first heating section of the plurality of parallel heating sections and a second heating section of the at least one transverse heating section.

Although several embodiments of the invention have been disclosed in the foregoing specification and the following appendices, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed herein, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A method comprising:
bending a first end portion of a first conductive plate toward a base portion of the first conductive plate such that the first end portion and the base portion of the first conductive plate define a receiving space;
inserting a first end portion of a carbon fiber tape layer within the receiving space of the first conductive plate;
further bending the first end portion of the first conductive plate to compress the first end portion of the carbon fiber tape layer within the receiving space of the first conductive plate;
bending a second, opposed end portion of the first conductive plate over the first end portion of the first conductive plate to form a first electrode.

2. The method of claim 1, wherein the conductive plate comprises copper.

3. The method of claim 1, wherein the first end portion, the second end portion, and the base portion of the first conductive plate have substantially equal lengths.

4. The method of claim 1, further comprising:
bending a first end portion of a second conductive plate toward a base portion of the second conductive plate such that the first end portion and the base portion of the second conductive plate define a receiving space;
inserting a first end portion of a carbon fiber tape layer within the receiving space of the second conductive plate;
further bending the first end portion of the second conductive plate to compress the first end portion of the carbon fiber tape layer within the receiving space of the second conductive plate; and
bending a second, opposed end portion of the second conductive plate over the first end portion of the first conductive plate to form a second electrode.

5. The method of claim 4, further comprising:
forming at least one hole through a portion of a thickness of each of the first and second electrodes, wherein the hole is configured to receive electrical wiring.

6. The method of claim 4, further comprising:
positioning a first conductive sheath layer in a desired layout; and
positioning the carbon fiber tape layer over the first conductive sheath layer such that the carbon fiber tape layer is supported in a desired pattern.

7. The method of claim 6, further comprising:
connecting electrical wiring configured to supply power to at least one of the first and second electrodes.

8. The method of claim 6, further comprising:
securing the first and second electrodes to a termination block.

9. The method of claim 7, further comprising:
positioning a second conductive sheath layer over the carbon fiber tape layer to form a heating element.

10. The method of claim 9, further comprising:
prior to positioning the carbon fiber tape layer over the first conductive sheath layer, positioning electrically insulating material on the first conductive sheath layer, wherein positioning the carbon fiber tape layer over the first conductive sheath layer comprises positioning the carbon fiber tape layer on the electrically insulating material positioned on the first conductive sheath layer.

11. The method of claim 10, further comprising:
prior to positioning the second conductive sheath layer over the carbon fiber tape layer, positioning electrically insulating material on the carbon fiber tape layer, wherein positioning the second conductive sheath layer over the carbon fiber tape layer comprises positioning the second conductive sheath layer on the electrically insulating material positioned on the carbon fiber tape layer.

12. The method of claim 7, further comprising:
connecting a grounding wire to one or more of the first and second conductive sheath layers through the first electrode.

13. The method of claim 7, further comprising:
applying an encapsulation layer over the heating element to define an outer surface of a heating pad, wherein the heating element is positioned within the encapsulation layer.

14. The method of claim 13, wherein the heating element comprises a plurality of heating sections.

15. The method of claim 14, further comprising:
positioning a thermally conductive material between the plurality of heating sections, wherein the thermally conductive material and the heating element cooperate to define a heating layer, and wherein the plurality of heating sections form a continuous structure within the heating pad.

16. The method of claim 15, wherein the outer surface of the heating pad comprises a contact portion and an opposing base portion, and wherein the contact portion is adjacent the heating layer and configured to permit transfer of heat from the plurality of heating sections to the contact portion.

17. The method of claim 13, further comprising:
prior to applying the encapsulation layer, positioning an insulation layer between the base portion of the outer surface of the heating pad and the heating layer.

18. The method of claim 15, wherein the plurality of heating sections comprises a plurality of parallel heating sections that are oriented substantially parallel to one another.

19. The method of claim 18, wherein the plurality of heating sections further comprise at least one transverse heating section oriented substantially perpendicular to the plurality of parallel heating sections, wherein at least two of the parallel heating sections are connected together via a transverse heating section.

20. The method of claim 19, wherein the first and second electrodes are secured, respectively, to a first heating section of the plurality of parallel heating sections and a second heating section of the at least one transverse heating section.
